(19) United States
(12) Patent Application Publication
(10) Pub. No.: US 2023/0216220 A1
(43) Pub. Date: Jul. 6, 2023

(54) PROTECTIVE SLEEVE CONFIGURED TO BE TOOL-LESSLY REMOVED FROM A CABLE ASSEMBLY

(71) Applicant: PPC BROADBAND, INC., East Syracuse, NY (US)

(72) Inventor: Roger MATHEWS, Syracuse, NY (US)

(73) Assignee: PPC BROADBAND, INC., East Syracuse, NY (US)

(21) Appl. No.: 18/091,518

(22) Filed: Dec. 30, 2022

Related U.S. Application Data
(60) Provisional application No. 63/295,480, filed on Dec. 30, 2021.

(51) Int. Cl. H01R 4/72; H01R 9/05; H01R 43/20

(52) U.S. Cl. CPC H01R 4/72; H01R 9/05; H01R 43/20; H01R 2103/00

(57) ABSTRACT

An assembly for covering at least a portion of a connector portion and at least a portion of a cable includes: a temperature sensitive portion; and a cord portion. The temperature sensitive portion is configured to have a pre-shrink length prior to being heated and a post-shrink length after being heated; wherein the post-shrink length is smaller than the pre-shrink length; the cord portion is configured to have a length after the temperature sensitive portion is heated that is greater than the post-shrink length of the temperature sensitive portion; and a difference between the post-shrink length of the temperature sensitive portion and the length of the cord portion after the heating permits a user to remove the temperature sensitive portion from a connector portion and a cable without using a sharp tool and thereby avoid cutting the connector portion or the cable when removing the temperature sensitive portion.

### CROSS-REFERENCE TO RELATED APPLICATION

This application claims the benefit of U.S. Provisional Application No. 63/295,480, which was filed on Dec. 30, 2021, the disclosure of which is hereby incorporated by reference herein in its entirety.

### BACKGROUND

The present disclosure generally relates to protective sleeves, and more particularly to a protective sleeve for cable assemblies that may include connectors or other components.

Coaxial cables are commonly utilized in RF communications systems. A typical coaxial cable includes an inner conductor, an outer conductor, a dielectric layer that separates the inner and outer conductors, and a jacket that covers the outer conductor. Coaxial cable connectors may be applied to terminate coaxial cables, for example, in communication systems requiring a high level of precision and reliability.

Coaxial connector interfaces provide a connect/disconnect functionality between a cable terminated with a connector bearing the desired connector interface and a corresponding connector with a mating connector interface mounted on an apparatus or on another cable. Typically, one connector will include a structure such as a pin or post connected to an inner conductor and an outer conductor connector body connected to the outer conductor; these are mated with a mating sleeve (for the pin or post of the inner conductor) and another outer conductor connector body of a second connector. Coaxial connector interfaces often utilize a threaded coupling nut or other retainer that draws the connector interface pair into secure electro-mechanical engagement when the coupling nut (which is captured by one of the connectors) is threaded onto the other connector. The interface between the cable and the connector is typically protected with a polymeric sleeve, tube or the like, often in the form of an over molded body that is injection molded over the end of the cable and a narrowed portion of the connector.

As an added layer of protection, a sleeve can be installed over the connector and a portion of the cable entering the connector. One example of such a sleeve is heat shrink tubing that is placed over the connector and a portion of the cable that extends from the connector and then heated to cause the tubing to shrink tightly around the connector and the portion of the cable. Removal of the sleeve/tubing might be necessary to access the connector for service and/or removal of the connector from the cable, or a box or other device to which the connector is attached.

One way to remove heat shrink tubing from a hard line, or other, connector and cable is to use a sharp tool, such as a knife. A technician can use a pointed end of the tool to score and split the heat shrink along the length, aiding in the removal of the heat shrink tubing. Some jurisdictions do not allow technicians to use pointed tools to remove heat shrink as a matter of safety. The tools that are allowed may have a pointed tip, but is may not be sharp enough to pierce the heat shrink tubing to start the process of removing it. Some technicians use a tool having a flat blade that is typically sharp enough to shave a part of the heat shrink tubing down the length of the tubing. The action of the technician shaving or skinning the heat shrink tubing from the outer surface of the connector/cable may cause flat spots to be introduced onto the cable outer shield and connector. The flat spots can cause weakening of the shield structure which may lead to premature failure. A flat spot on the cable shield may also compromise the connector's ability to effectively seal out moisture. In addition, the connector's outer surfaces can also be effected by such shaving. For example, the outer plating or coating can be compromised, effecting the connector's ability to defend against corrosion.

Therefore, it may be desirable to provide a simple way to remove a sleeve/tubing from a connector and cable without damaging the outer surface of the connector or cable.

### SUMMARY

In accordance with various embodiments of the disclosure, a heat shrink sleeve and a rip cord having different lengths of the heat shrink sleeve and the rip cord after heating permit a user to remove the heat shrink sleeve from a connector and/or cable without using a sharp tool and thereby avoid cutting the connector and/or the cable when removing the heat shrink sleeve. Although exemplary embodiments described in the disclosure relate to coaxial cables and connectors, the invention is not limited to coaxial cables or coaxial connectors and can be used for other types of cables or connectors, such as optical fiber cable or optical fiber connectors.

Embodiments of the disclosure include a non-shrinking rip (or splitting) cord strategically embedded longitudinally in heat shrink sleeve (or tubing). The heat shrink sleeve is applied to the connector and cable, usually by heating, causing the sleeve to activate and shrink in size down onto the connector and cable. When heat shrink sleeve is heated, the size of the sleeve becomes smaller in diameter as well as in length. Heating heat shrink sleeve that has a non-shrinking cord embedded in the sleeve (or an adhesive on the sleeve) results in the cord being exposed at ends of the sleeve once the sleeve is heated sufficiently to shrink the sleeve. This exposes the cord to a technician so that the technician can pull the cord to create a slit or opening down the length of the heat shrink sleeve without using a knife or other sharp tool. This allows the heat shrink sleeve to be easily removed.

Embodiments provide an enveloping assembly for enveloping at least a portion of a connector and at least a portion of a cable. The assembly includes: a heat shrink sleeve; a layer of adhesive; and a rip cord. A difference between a post-shrink length of the heat shrink sleeve and a length of the rip cord after heating permits a user to remove the heat shrink sleeve from a connector and a cable without using a sharp tool and thereby avoid cutting the connector or the cable when removing the heat shrink sleeve.

In some aspects, the layer of adhesive is configured to be located on an inside surface of the heat shrink sleeve.

In some aspects, the rip cord is configured to be embedded in the layer of adhesive,

In some aspects, the heat shrink sleeve is configured to have a pre-shrink perimeter and a pre-shrink length prior to being heated.

In some aspects, the heat shrink sleeve is configured to have a post-shrink perimeter and a post-shrink length after being heated.

In some aspects, the post-shrink perimeter is smaller than the pre-shrink perimeter.

In some aspects, the post-shrink length is smaller than the pre-shrink length.

In some aspects, the rip cord has a length equal to the pre-shrink length of the heat shrink sleeve.

In some aspects, the rip cord is configured such that a length of the rip cord is the same before and after the heat shrink sleeve is heated.

In some aspects, the layer of adhesive has a thickness in a radial direction of the sleeve.

In some aspects, the thickness of the layer of adhesive prior to heating the heat shrink sleeve is equal to a thickness of the rip cord.

In some aspects, the rip cord is configured to tear the heat shrink sleeve as a result of the rip cord being pulled radially outward relative to the heat shrink sleeve.

In some aspects, the connector is a coaxial connector.

In some aspects, the cable is a coaxial cable.

In some aspects, the rip cord extends beyond an end of the heat shrink sleeve after the heat shrink sleeve is heated.

Embodiments provide an assembly for covering at least a portion of connector portion and at least a portion of a cable. The assembly includes: a temperature sensitive portion; an adhesive portion; and a cord portion. A difference between a post-shrink length of the temperature sensitive portion and a length of the cord portion after heating permits a user to remove the temperature sensitive portion from a connector portion and a cable without using a sharp tool and thereby avoid cutting the connector portion or the cable portion when removing the temperature sensitive portion.

In some aspects, the adhesive portion is configured to be located on an inside surface of the temperature sensitive portion.

In some aspects, the cord portion is configured to contact the adhesive portion.

In some aspects, the temperature sensitive portion is configured to have a pre-shrink length prior to being heated.

In some aspects, the temperature sensitive portion is configured to have a post-shrink length after being heated.

In some aspects, the post-shrink length is smaller than the pre-shrink length.

In some aspects, the cord portion is configured to have a length after the temperature sensitive portion is heated that is greater than the post-shrink length of the temperature sensitive portion.

In some aspects, the cord portion is configured to tear the temperature sensitive portion as a result of the cord portion being pulled radially outward relative to the temperature sensitive portion.

In some aspects, the connector portion is a coaxial connector.

In some aspects, the cable is a coaxial cable.

In some aspects, the temperature sensitive portion is configured to have a pre-shrink perimeter prior to being heated.

In some aspects, the temperature sensitive portion is configured to have a post-shrink perimeter after being heated.

In some aspects, the post-shrink perimeter is smaller than the pre-shrink perimeter.

In some aspects, the pre-shrink perimeter of the temperature sensitive portion is configured to be a circle.

In some aspects, the cord portion is configured to extend beyond an end of the temperature sensitive portion after the temperature sensitive portion is heated.

In some aspects, the temperature sensitive portion is configured to be a heat shrink sleeve.

In some aspects, the cord portion is configured to be embedded in the adhesive.

In some aspects, the cord portion is configured to have a length equal to the pre-shrink length of the temperature sensitive portion.

In some aspects, the cord portion is configured such that a length of the cord portion is the same before and after the temperature sensitive portion is heated.

In some aspects, the adhesive portion has a thickness in a radial direction of the temperature sensitive portion; and wherein the thickness of the adhesive portion prior to heating the temperature sensitive portion is equal to a thickness of the cord portion.

Embodiments provide an assembly for covering at least a portion of a connector portion and at least a portion of a cable. The assembly includes: a temperature sensitive portion; and a cord portion. A difference between a post-shrink length of the temperature sensitive portion and a length of the cord portion after heating permits a user to remove the temperature sensitive portion from a connector portion and a cable without using a sharp tool and thereby avoid cutting the connector portion or the cable portion when removing the temperature sensitive portion.

In some aspects, the temperature sensitive portion is configured to have a pre-shrink length prior to being heated.

In some aspects, the temperature sensitive portion is configured to have a post-shrink length after being heated; the post-shrink length is smaller than the pre-shrink length.

In some aspects, the cord portion is configured to have a length after the temperature sensitive portion is heated that is greater than the post-shrink length of the temperature sensitive portion.

In some aspects, the connector portion is a coaxial connector.

In some aspects, the cable is a coaxial cable.

In some aspects, the cord portion is configured to tear the temperature sensitive portion as a result of the cord portion being pulled radially outwardly relative to the temperature sensitive portion.

In some aspects, the cord portion is configured to be embedded in the temperature sensitive portion.

In some aspects, the assembly further comprises an adhesive portion.

In some aspects, the adhesive portion is configured to be located on an inside surface of the temperature sensitive portion.

In some aspects, the cord portion is configured to contact the adhesive portion.

In some aspects, the temperature sensitive portion is a heat shrink sleeve.

In some aspects, the temperature sensitive portion is configured to have a pre-shrink perimeter prior to being heated.

In some aspects, the temperature sensitive portion is configured to have a post-shrink perimeter after being heated.

In some aspects, the post-shrink perimeter is smaller than the pre-shrink perimeter.

In some aspects, the cord portion extends beyond an end of the temperature sensitive portion after the temperature sensitive portion is heated.

In some aspects, the cord portion is configured to have a length equal to the pre-shrink length of the temperature sensitive portion.

In some aspects, the cord portion is configured such that a length of the cord portion is the same before and after the temperature sensitive portion is heated.

Various aspects of the system, as well as other embodiments, objects, features and advantages of this disclosure, will be apparent from the following detailed description of illustrative embodiments thereof, which is to be read in conjunction with the accompanying drawings.

### BRIEF DESCRIPTION OF THE DRAWINGS

FIG. 1 is an expanded perspective view of an exemplary cable and connector.

FIG. 2 is a side sectional view of an exemplary sleeve in accordance with embodiments of the disclosure in position over the cable and connector of FIG. 1.

FIG. 3 is a perspective view of an exemplary sleeve in accordance with embodiments of the disclosure and a cable prior to removing a splitting cord.

FIG. 4 is a perspective view of the sleeve of FIG. 3 after partially removing the splitting cord.

FIG. 5 is a perspective view of an exemplary sleeve in accordance with embodiments of the disclosure.

### DETAILED DESCRIPTION OF EMBODIMENTS

Embodiments of the disclosure provide a heat shrink sleeve and a rip cord such that different lengths of the heat shrink sleeve and the rip cord after heating permit a user to remove the heat shrink sleeve from a connector and/or cable without using a sharp tool and thereby avoid cutting the connector and/or the cable when removing the heat shrink sleeve.

Reference will now be made in detail to compositions, embodiments and methods of the present disclosure, which constitute the best modes of practicing the present disclosure presently known to the inventors. It is to be understood that the disclosed embodiments are merely exemplary of the present disclosure that may be embodied in various and alternative forms. Therefore, specific details disclosed herein are not to be interpreted as limiting, but merely as a representative basis for any aspect of the present disclosure and/or as a representative basis for teaching one skilled in the art to variously employ the present disclosure.

It is also to be understood that this present disclosure is not limited to the specific embodiments and methods described below, as specific components and/or conditions may, of course, vary. Furthermore, the terminology used herein is used only for the purpose of describing particular embodiments of the present disclosure and is not intended to be limiting in any way.

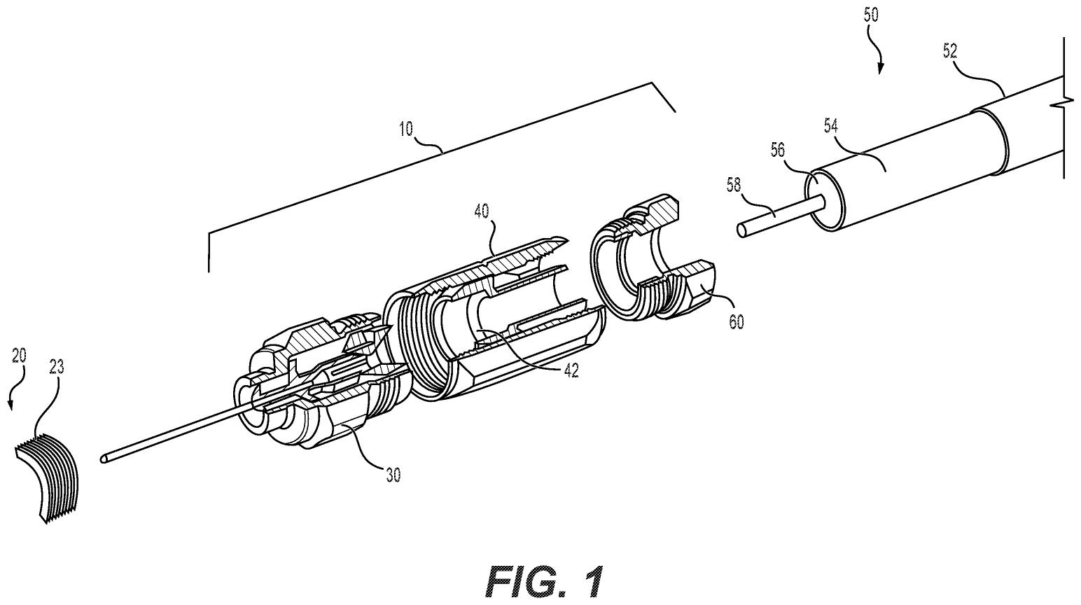

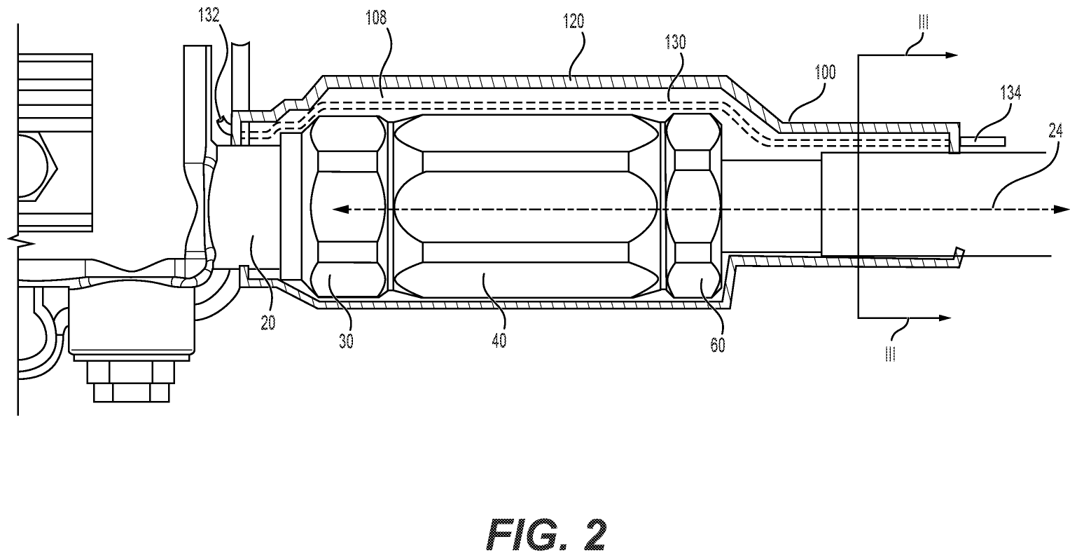

Referring now to the figures, an example of a connector portion, such as, for example, connector 10, (in this example, a hardline connector) and a cable portion, such as, for example, cable 50, are shown in FIG. 1. FIG. 2 shows the connector 10 attached to the cable 50 and surrounded by a sleeve in accordance with embodiments of the disclosure. The connector 10 can be a plug, a jack, or another variety of connector that can be connected to a mating connector. The connector 10 shown in FIGS. 1 and 2 is a hardline coaxial cable connector. The coaxial cable connector 10 can be operably affixed, or otherwise functionally attached, to the coaxial cable 50 having a protective outer jacket 52, an outer conductor 54, a dielectric 56, and a center conductor 58. The protective outer jacket 52 is intended to protect the various components of the coaxial cable 50 from damage (such as, for example, corrosion) which can result from exposure to dirt or moisture.

Referring further to FIG. 1, the connector 10 can be configured to be coupled with a coaxial cable interface port 20 having a threaded exterior surface 23. In this example the connector 10 includes a coupler 30, a connector body 40, a post 42, and a back nut 60. The coupler 30 is configured to attach the connector 10 to the interface port 20.

As shown in FIG. 2, an exemplary assembly 100 includes a temperature sensitive portion, such as, for example, a heat shrink sleeve 120, that overlies a portion of cable 50, connector 10, and a portion of the interface port 20. In embodiments, the heat shrink sleeve 120 is formed of a material, such as a cross-linked polyolefin, that shrinks when heated. In embodiments, the heat shrink sleeve 120 is a dual-layer tube having an outer layer of a cross-linked polyolefin and an inner layer of a hot melt adhesive. In some embodiments, it may be desirable for the inner diameter of the heat shrink sleeve 120 to shrink to about one-third of its original diameter.

In embodiments, the heat shrink sleeve 12 can have a thickness of between about 1.25 and 2.25 mm, and in some embodiments between about 1.4 and 2.0 mm. In embodiments, the heat shrink sleeve 120 can have a length of between about 40 and 60 mm. It will also be understood that, in some embodiments, more than one layer of heat shrink sleeve 120 may be applied. For example, positive results have been achieved with two overlying layers of heat-shrink sleeves 120.

As noted above and as can be seen in FIG. 2, after shrinking due to the application of heat, the heat shrink sleeve 120 conformably overlies the end of the cable 50, the connector 10, and a portion of the interface port 20. In this example, the assembly 100 includes an adhesive, such as, for example, an adhesive layer 108, and the ripcord 130. In embodiments, the thickness of the adhesive layer 108 is equal to the thickness of the rip cord 130 prior to heating the heat shrink sleeve 120. In embodiments, the thickness of the adhesive layer 108 is less than the thickness of the rip cord 130 prior to heating the heat shrink sleeve. In embodiments, the thickness of the adhesive layer 108 is greater than the thickness of the rip cord 130 prior to heating the heat shrink sleeve. It is noted that the underlying structures may have different sizes, dimensions and/or shapes and still be suitable for use with embodiments of this disclosure.

The heat-shrink sleeve 120 can be applied by inserting a terminated cable (i.e., the cable 50 with the connector 10 attached thereto) into the hollow core of the sleeve 120, connecting the connector to the interface port 20, and then heating the sleeve 120 to cause it to shrink to conformably cover the end of the cable 50, the connector 10, and a portion of the interface port 20. In embodiments, heating can be performed at a temperature of between about 125 and 200 degrees C.

Inclusion of the heat shrink sleeve 120 can provide environmental sealing of the interface as well as robust strain relief and mechanical protection for the connector 10. Insulation and abrasion resistance may also be increased by use of the heat shrink sleeve 120.

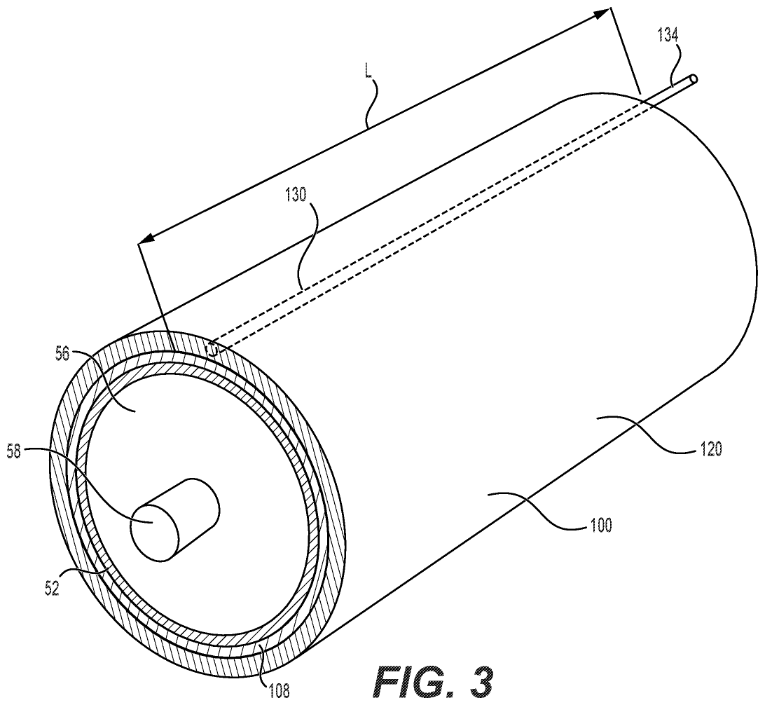

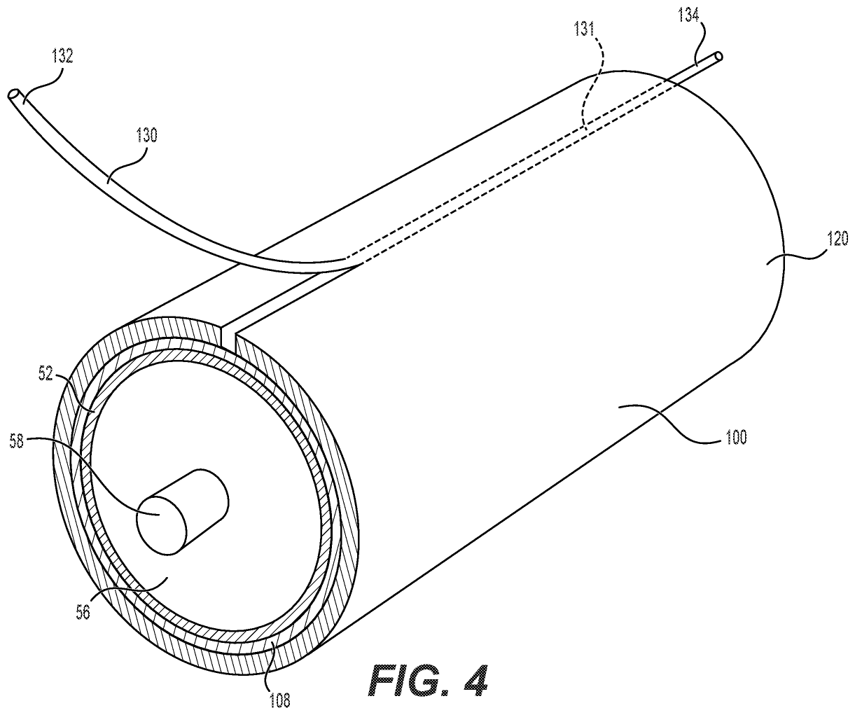

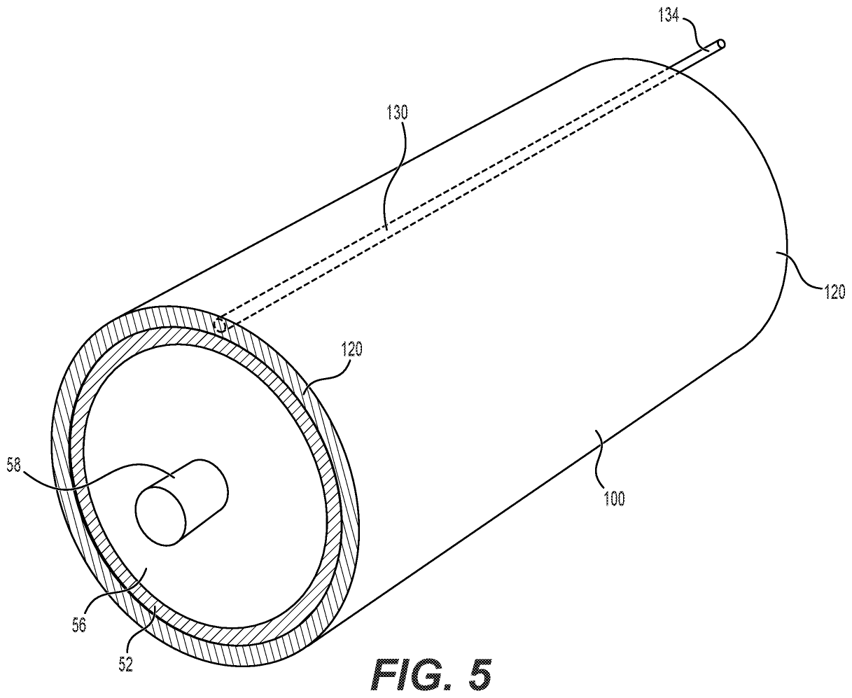

FIGS. 3 and 4 show the assembly 100 after shrinking due to the application of heat. In embodiments, the adhesive layer 108 is provided on in inside surface of the heat shrink sleeve 120. In embodiments, the ripcord 130 is disposed within the adhesive layer 108, as shown in FIGS. 3 and 4. In the exemplary embodiment shown in FIG. 5, the adhesive layer 108 shown in FIGS. 3 and 4 is omitted, and the ripcord 130 is disposed within the heat shrink sleeve 120 so that the material of the heat shrink sleeve 120 surrounds the ripcord 130. In embodiments, the diameter of the ripcord 130 is smaller than the thickness of the heat shrink sleeve. In embodiments, the diameter of the ripcord 130 is large than the thickness of the heat shrink sleeve at allocation other than the location of the ripcord 130. Regardless of whether or not an adhesive layer 108 is used, in embodiments, after shrinking the heat shrink sleeve 120, the ripcord 130 extends along a length L of the shrunk heat shrink sleeve 120 and extends beyond the length L at both ends to form extensions 132, 134. The extensions 132, 134 (also shown in FIG. 2) of the ripcord 130 result from the rip cord maintaining its original length (not shrinking) when the heat shrink sleeve 120 shrinks. The extensions 132, 134 can be gripped by the technician (either using their fingers or pliers, or another tool) and pulled (as shown in FIG. 4) to pull the ripcord 130 radially outwardly through an upper layer of the ripcord 130 (in the case of the ripcord 130 being embedded in the heat shrink sleeve 110) to weaken the heat shrink sleeve 110 so that it can be easily torn and removed by the technician. The extensions 132, 134 can be gripped by the technician (either using their fingers or pliers, or another tool) and pulled (as shown in FIG. 4) to pull the ripcord 130 through the entire thickness of the ripcord 130 (in the case of the ripcord 130 being embedded in the adhesive layer 108) to completely sever the heat shrink sleeve 110 so that it can be easily removed by the technician with no need for further tearing of the heat shrink sleeve 120.

The above exemplary embodiments provide a heat shrink sleeve and a rip cord such that different lengths of the heat shrink sleeve and the rip cord after heating permit a user to remove the heat shrink sleeve from a connector and/or cable without using a sharp tool and thereby avoid cutting the connector and/or the cable when removing the heat shrink sleeve.

Although the illustrative embodiments of the present invention have been described herein with reference to the accompanying drawings, it is to be understood that the invention is not limited to those precise embodiments, and that various other changes and modifications may be effected therein by one skilled in the art without departing from the scope or spirit of the invention.

Various changes to the foregoing described and shown structures will now be evident to those skilled in the art. Accordingly, the particularly disclosed scope of the invention is set forth in the following claims.

What is claimed is:

1. An enveloping assembly for enveloping at least a portion of a connector and at least a portion of a cable comprising:
a heat shrink sleeve;
a layer of adhesive;
a rip cord;
wherein the layer of adhesive is configured to be located on an inside surface of the heat shrink sleeve;
wherein the rip cord is configured to be embedded in the layer of adhesive;
wherein the heat shrink sleeve is configured to have a pre-shrink perimeter and a pre-shrink length prior to being heated;
wherein the heat shrink sleeve is configured to have a post-shrink perimeter and a post-shrink length after being heated;
wherein the post-shrink perimeter is smaller than the pre-shrink perimeter;
wherein the post-shrink length is smaller than the pre-shrink length;
wherein the rip cord has a length equal to the pre-shrink length of the heat shrink sleeve;
wherein the rip cord is configured such that a length of the rip cord is the same before and after the heat shrink sleeve is heated;
wherein the layer of adhesive has a thickness in a radial direction of the sleeve;
wherein the thickness of the layer of adhesive prior to heating the heat shrink sleeve is equal to a thickness of the rip cord;
wherein the rip cord is configured to tear the heat shrink sleeve as a result of the rip cord being pulled radially outward relative to the heat shrink sleeve; and
wherein a difference between the post-shrink length of the heat shrink sleeve and the length of the rip cord after the heating permits a user to remove the heat shrink sleeve from a connector and a cable without using a sharp tool and thereby avoid cutting the connector or the cable when removing the heat shrink sleeve.

2. The assembly of claim 1, wherein the connector is a coaxial connector.

3. The assembly of claim 1, wherein the cable is a coaxial cable.

4. The assembly of claim 1, wherein the rip cord extends beyond an end of the heat shrink sleeve after the heat shrink sleeve is heated.

5. An assembly for covering at least a portion of connector portion and at least a portion of a cable comprising:
a temperature sensitive portion;
an adhesive portion;
a cord portion;
wherein the adhesive portion is configured to be located on an inside surface of the temperature sensitive portion;
wherein the cord portion is configured to contact the adhesive portion;
wherein the temperature sensitive portion is configured to have a pre-shrink length prior to being heated;
wherein the temperature sensitive portion is configured to have a post-shrink length after being heated;
wherein the post-shrink length is smaller than the pre-shrink length;
wherein the cord portion is configured to have a length after the temperature sensitive portion is heated that is greater than the post-shrink length of the temperature sensitive portion;
wherein the cord portion is configured to tear the temperature sensitive portion as a result of the cord portion being pulled radially outward relative to the temperature sensitive portion; and
wherein a difference between the post-shrink length of the temperature sensitive portion and the length of the cord portion after the heating permits a user to remove the temperature sensitive portion from a connector portion and a cable without using a sharp tool and thereby avoid cutting the connector portion or the cable when removing the temperature sensitive portion.

6. The assembly of claim 5, wherein the connector portion is a coaxial connector.

7. The assembly of claim 5, wherein the cable is a coaxial cable.

8. The assembly of claim 5, wherein the temperature sensitive portion is configured to have a pre-shrink perimeter prior to being heated;
wherein the temperature sensitive portion is configured to have a post-shrink perimeter after being heated; and
wherein the post-shrink perimeter is smaller than the pre-shrink perimeter.

9. The assembly of claim 8, wherein the pre-shrink perimeter of the temperature sensitive portion is configured to be a circle.

10. The assembly of claim 5, wherein the cord portion is configured to extend beyond an end of the temperature sensitive portion after the temperature sensitive portion is heated.

11. The assembly of claim 5, wherein the temperature sensitive portion is configured to be a heat shrink sleeve.

12. The assembly of claim 5, wherein the cord portion is configured to be embedded in the adhesive.

13. The assembly of claim 5, wherein the cord portion is configured to have a length equal to the pre-shrink length of the temperature sensitive portion.

14. The assembly of claim 5, wherein the cord portion is configured such that a length of the cord portion is the same before and after the temperature sensitive portion is heated.

15. The assembly of claim 5, wherein the adhesive portion has a thickness in a radial direction of the temperature sensitive portion; and wherein the thickness of the adhesive portion prior to heating the temperature sensitive portion is equal to a thickness of the cord portion.

16. An assembly for covering at least a portion of a connector portion and at least a portion of a cable comprising:
a temperature sensitive portion;
a cord portion;
wherein the temperature sensitive portion is configured to have a pre-shrink length prior to being heated;
wherein the temperature sensitive portion is configured to have a post-shrink length after being heated;
wherein the post-shrink length is smaller than the pre-shrink length;
wherein the cord portion is configured to have a length after the temperature sensitive portion is heated that is greater than the post-shrink length of the temperature sensitive portion; and
wherein a difference between the post-shrink length of the temperature sensitive portion and the length of the cord portion after the heating permits a user to remove the temperature sensitive portion from a connector portion and a cable without using a sharp tool and thereby avoid cutting the connector portion or the cable when removing the temperature sensitive portion.

17. The assembly of claim 16, wherein the connector portion is a coaxial connector.

18. The assembly of claim 16, wherein the cable is a coaxial cable.

19. The assembly of claim 16, wherein the cord portion is configured to tear the temperature sensitive portion as a result of the cord portion being pulled radially outwardly relative to the temperature sensitive portion.

20. The assembly of claim 16, wherein the cord portion is configured to be embedded in the temperature sensitive portion.

21. The assembly of claim 16, further comprising an adhesive portion.

22. The assembly of claim 21, wherein the adhesive portion is configured to be located on an inside surface of the temperature sensitive portion.

23. The assembly of claim 22, wherein the cord portion is configured to contact the adhesive portion.

24. The assembly of claim 16, wherein the temperature sensitive portion is a heat shrink sleeve.

25. The assembly of claim 16, wherein the temperature sensitive portion is configured to have a pre-shrink perimeter prior to being heated;
wherein the temperature sensitive portion is configured to have a post-shrink perimeter after being heated; and
wherein the post-shrink perimeter is smaller than the pre-shrink perimeter.

26. The assembly of claim 16, wherein the cord portion extends beyond an end of the temperature sensitive portion after the temperature sensitive portion is heated.

27. The assembly of claim 16, wherein the cord portion is configured to have a length equal to the pre-shrink length of the temperature sensitive portion.

28. The assembly of claim 16, wherein the cord portion is configured such that a length of the cord portion is the same before and after the temperature sensitive portion is heated.
